(19) United States
(12) Patent Application Publication
(10) Pub. No.: US 2026/0274107 A1
(43) Pub. Date: Sep. 17, 2026

(54) CHARGING SYSTEM

(71) Applicant: TOYOTA JIDOSHA KABUSHIKI KAISHA, Toyota-shi (JP)

(72) Inventor: Shun SATO, Toyota-shi (JP)

(73) Assignee: TOYOTA JIDOSHA KABUSHIKI KAISHA, Toyota-shi (JP)

(21) Appl. No.: 19/558,761

(22) Filed: Mar. 6, 2026

(30) Foreign Application Priority Data
Mar. 13, 2025 (JP) 2025-040123

(51) Int. Cl. B60L 53/66; B60L 53/16; B60L 53/62; B60L 53/68

(52) U.S. Cl. CPC B60L 53/66; B60L 53/16; B60L 53/62; B60L 53/68; B60L 2240/547; B60L 2240/70; B60L 2240/80; B60L 2260/40

(57) ABSTRACT

A vehicle is configured such that a charging mode of the vehicle is switched between an unplanned charging mode and a planned charging mode. A management server is configured to generate a charging plan and transmit the charging plan to a power supply facility when an operation of switching from the unplanned charging mode to the planned charging mode is performed. The power supply facility is configured to output, when receiving the charging plan from the management server, a charging command to the vehicle in accordance with the charging plan. The controller is configured to prohibit charging of the battery until a predetermined prescribed time elapses on condition that an operation of switching from the unplanned charging mode to the planned charging mode is performed.

### CROSS-REFERENCE TO RELATED APPLICATIONS

This application is based upon and claims the benefit of priority from Japanese Patent Application No. 2025-040123, filed on Mar. 13, 2025, the entire contents of which are incorporated herein by reference.

### BACKGROUND

### 1. Field

The present disclosure relates to a charging system.

### 2. Description of Related Art

JP2023-165164A discloses a charging system. The charging system includes a management server, a power supply facility communicable with the management server, and a vehicle that includes a battery and is communicable with the management server. The management server generates a charging plan for charging the battery of the vehicle. When receiving the charging plan from the management server, the power supply facility outputs a charging command to the vehicle in accordance with the charging plan.

When the power supply facility does not receive a charging plan from the management server, the power supply facility outputs a charging command to the vehicle upon connection of the charging connector of a power supply facility to a charging port of the vehicle, regardless of any charging plan. Accordingly, the vehicle starts charging the battery when the charging connector of the power supply facility is connected to the charging port of the vehicle.

In a charging system such as that described in the above publication, an operation may be performed on the vehicle to switch a charging mode of the vehicle from an unplanned charging mode to a planned charging mode. In the unplanned charging mode, the vehicle starts charging the battery when the charging connector of the power supply facility is connected to the charging port of the vehicle, regardless of any charging plan. In the planned charging mode, the vehicle starts charging the battery in accordance with the charging plan.

When an operation is performed to switch the charging mode from the unplanned charging mode to the planned charging mode, the vehicle may transmit a signal indicating the charging mode to the management server. When the management server receives a signal indicating that the charging mode is the planned charging mode, the management server may transmit the charging plan to the power supply facility.

In this case, a delay may occur between the time when the operation to switch the charging mode from the unplanned charging mode to the planned charging mode is performed on the vehicle and the time when the power supply facility receives the charging plan. As a result, during the period from when the charging mode is switched from the unplanned charging mode to the planned charging mode until the power supply facility receives the charging plan, unintended charging of the battery may be performed contrary to the intention of the vehicle user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a charging system includes a management server, a power supply facility configured to communicate with the management server, and a vehicle configured to communicate with the management server. The vehicle includes a battery, a charging port, and a controller configured to control the battery. The power supply facility includes a charging connector configured to be connected to the charging port. The management server is configured to generate a charging plan for charging the battery. The power supply facility is configured to output a charging command for charging the battery to the vehicle. The vehicle is configured such that a charging mode of the vehicle is switched between an unplanned charging mode and a planned charging mode. The unplanned charging mode is a mode in which charging of the battery is started when the charging connector is connected to the charging port regardless of the charging plan. The planned charging mode is a mode in which the battery is charged by the charging command from the power supply facility in accordance with the charging plan. The vehicle is configured to transmit, to the management server, a switching notification indicating that the charging mode of the vehicle has been switched from the unplanned charging mode to the planned charging mode, when an operation of switching from the unplanned charging mode to the planned charging mode is performed. The management server is configured to generate, when receiving the switching notification from the vehicle, the charging plan and transmit the charging plan to the power supply facility. The power supply facility is configured to output, when receiving the charging plan from the management server, the charging command to the vehicle in accordance with the charging plan. The controller is configured to prohibit charging of the battery until a predetermined prescribed time elapses on condition that the operation of switching from the unplanned charging mode to the planned charging mode is performed.

Other features and aspects will be apparent from the following detailed description, the drawings, and the claims.

### BRIEF DESCRIPTION OF THE DRAWINGS

FIG. 1 is a schematic diagram showing a charging system according to an embodiment.

FIG. 2 is an explanatory diagram showing flows of signals in the charging system of FIG. 1.

FIG. 3 is a flowchart showing a series of processes including prohibition of charging performed by the vehicle of FIG. 1.

FIG. 4 is a timing diagram showing changes when a switching operation is performed in the charging system of FIG. 1, in which part (a) indicates a charging mode as recognized by the vehicle over time, part (b) indicates the charging mode as recognized by the management server over time, part (c) indicates whether charging is performed in accordance with a charging plan, part (d) indicates whether a charging command is issued, and part (e) indicates whether the vehicle is being charged.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

A charging system 10 according to an embodiment will now be described with reference to the drawings.

### Outline of Charging System

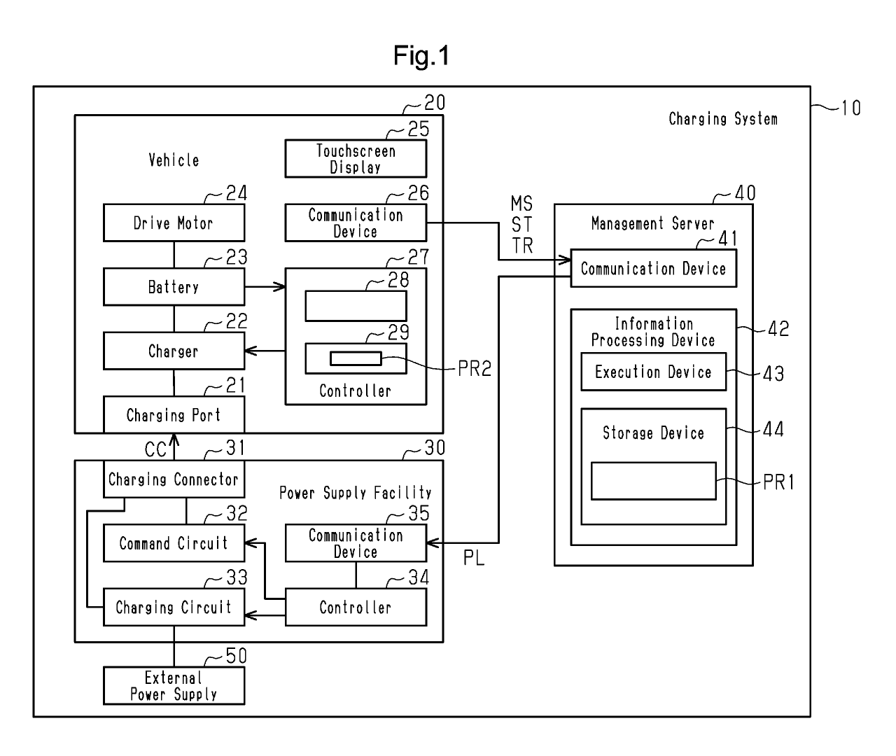

As shown in FIG. 1, the charging system 10 includes a vehicle 20, a power supply facility 30, a management server 40, and an external power supply 50. The charging system 10 manages charging of the vehicle 20 by the power supply facility 30.

The vehicle 20 includes a charging port 21, a charger 22, a battery 23, and a drive motor 24. The vehicle 20 is a battery electric vehicle. A charging connector 31 of the power supply facility 30 can be connected to the charging port 21. When the charging connector 31 is connected to the charging port 21, the battery 23 can be charged by the power supply facility 30.

The drive motor 24 is a drive source for the vehicle 20. The drive motor 24 drives the vehicle 20 using electrical energy stored in the battery 23. The battery 23 stores electrical energy for operating the drive motor 24.

The charger 22 includes a relay that switches connection and disconnection of an electric power path between the charging port 21 and the battery 23, and a power conversion circuit. The battery 23 is charged by controlling the charger 22.

The vehicle 20 includes a touchscreen display 25, a communication device 26, and a controller 27.

The touchscreen display 25 displays an image such as map information. The touchscreen display 25 receives an operation signal when a touch operation is performed by the user. In the present embodiment, the touchscreen display 25 displays an image for setting the charging mode so that a touch operation for switching from the unplanned charging mode MD1 to the planned charging mode MD2 can be received. When the touch operation is performed, the touchscreen display 25 receives an operation signal indicating the switching operation. When the touchscreen display 25 receives the operation signal indicating the switching operation, the touchscreen display 25 outputs the operation signal indicating the switching operation to the controller 27.

The unplanned charging mode MD1 is a charging mode in which charging of the battery 23 is started when the charging connector 31 of the power supply facility 30 is connected to the charging port 21, regardless of a charging plan PL generated by the management server 40.

The planned charging mode MD2 is a charging mode in which charging of the battery 23 is started by a charging command CC from the power supply facility 30 in accordance with the charging plan PL generated by the management server 40 even when the charging connector 31 of the power supply facility 30 is connected to the charging port 21.

The touchscreen display 25 displays an image for setting a target value of the charging plan PL so that a touch operation for inputting information necessary for the management server 40 to generate the charging plan PL can be received. When the touch operation is performed, the touchscreen display 25 receives a next scheduled use time ST and a target state of charge TR as the target values of the charging plan PL. When the touchscreen display 25 receives the next scheduled use time ST and the target state of charge TR, the touchscreen display 25 outputs the next scheduled use time ST and the target state of charge TR to the controller 27.

The controller 27 controls the charger 22 to charge the battery 23. When the controller 27 detects that the charging connector 31 is connected to the charging port 21, the controller 27 controls the charger 22 to start charging the battery 23. The controller 27 refers to the state of charge SOC of the battery 23, and controls the charger 22 to end the charging of the battery 23 in accordance with the state of charge SOC. The controller 27 controls the communication device 26 so as to transmit various signals from the communication device 26 to the management server 40.

The controller 27 includes an execution device 28, which is processing circuitry, and a storage device 29. The execution device 28 is a CPU. The storage device 29 is a memory module. The storage device 29 stores a charging prohibition program PR2. The charging prohibition program PR2 is a program to be executed by the execution device 28. A process when the charging prohibition program PR2 is executed will be described later.

The communication device 26 can communicate with the management server 40 via a wireless communication line. When the communication device 26 receives an operation signal indicating a switching operation from the unplanned charging mode MD1 to the planned charging mode MD2 from the controller 27, the communication device 26 transmits a switching notification MS to the management server 40. When the communication device 26 receives the next scheduled use time ST and the target state of charge TR from the controller 27, the communication device 26 transmits the next scheduled use time ST and the target state of charge TR to the management server 40.

The power supply facility 30 supplies electric power from the external power supply 50 to the corresponding vehicle 20 to charge the battery 23 of the vehicle 20. The power supply facility 30 is so-called electric vehicle supply equipment (EVSE). The power supply facility 30 includes the charging connector 31, a command circuit 32, a charging circuit 33, a controller 34, and a communication device 35.

Each charging connector 31 is connectable to the charging port 21 of the corresponding vehicle 20. The charging connector 31 is connected to the command circuit 32 by a cable. The charging connector 31 is connected to the external power supply 50 via the charging circuit 33 by a cable. The external power supply 50 is located outside the vehicle 20. Connecting the charging connector 31 to the charging port 21 allows the power supply facility 30 to supply electric power from the external power supply 50 to the battery 23 via the charging circuit 33.

The command circuit 32 is a circuit for transmitting the charging command CC to the vehicle 20. In a state in which the charging connector 31 is connected to the charging port 21, the command circuit 32 can transmit the charging command CC to the vehicle 20. The charge command CC includes a command of a charge amount per unit time. The command circuit 32 repeatedly outputs the charging command CC at all times when the battery 23 is charged in the unplanned charging mode MD1. When the battery 23 is charged in the planned charging mode MD2, the command circuit 32 does not output the charging command CC until the start time TS is reached.

The charging circuit 33 charges the battery 23 from the external power supply 50. Connecting the charging connector 31 to the charging port 21 allows the charging circuit 33 to supply electric power from the external power supply 50 to the battery 23.

The communication device 35 can communicate with the management server 40 via a wireless communication line. The communication device 35 receives information indicating the charging plan PL from the management server 40.

The controller 34 selects one of the unplanned charging mode MD1 and the planned charging mode MD2, and controls the power supply from the external power supply 50 to the battery 23 in the vehicle 20.

When the controller 34 receives the charging plan PL from the management server 40, the controller 34 selects the planned charging mode MD2. In the planned charging mode MD2, the controller 34 controls the supply of power from the external power supply 50 to the battery 23 in accordance with the charging plan PL acquired from the management server 40 via the communication device 35. The charging plan PL is time-series data of required electric power indicating a required charging amount per unit time in a predetermined period.

When the controller 34 detects that the charging connector 31 is connected to the charging port 21 without receiving the charging plan PL from the management server 40, the controller 34 selects the unplanned charging mode MD1. In the unplanned charging mode MD1, regardless of the charging plan PL, when the charging connector 31 is connected to the charging port 21, the controller 34 starts power supply from the external power supply 50 to the battery 23.

The management server 40 includes a communication device 41 and an information processing device 42. The communication device 41 can communicate with the vehicle 20 and the power supply facility 30 via a wireless communication line. The communication device 41 receives the switching notification MS from the vehicle 20. The communication device 41 receives a signal indicating the next scheduled use time ST and a signal indicating the target state of charge TR from the vehicle 20. The communication device 41 transmits charging plan PL to the power supply facility 30.

The information processing device 42 includes an execution device 43 and a storage device 44. The execution device 43 is a CPU including a processor. The storage device 44 is a memory module. The storage device 44 stores a generation program PR1.

When the generation program PR1 is executed, the execution device 43 generates the charging plan PL on the basis of the next scheduled use time TS and the target state of charge TR. Specifically, the execution device 43 calculates a start time TS at which charging is to be started when the battery 23 is charged with a predetermined amount of charge per unit time such that the state of charge SOC reaches the target state of charge TR at the next scheduled use time ST. The execution device 43 generates a charging plan PL for charging the battery 23 with a predetermined charge amount per unit time from the start time TS to the next scheduled use time ST. The execution device 43 may generate the charging plan PL in which the charging amount per unit time varies depending on the time zone, for example, on the basis of the power rate that varies depending on the time zone.

When the communication device 41 receives the switching notification MS, the execution device 43 starts execution of the generation program PR1. The information processing device 42 transmits a signal indicating the generated charging plan PL from the communication device 41 to the power supply facility 30.

### FLOW OF SIGNAL WHEN SWITCHING OPERATION IS PERFORMED IN MANAGEMENT SYSTEM

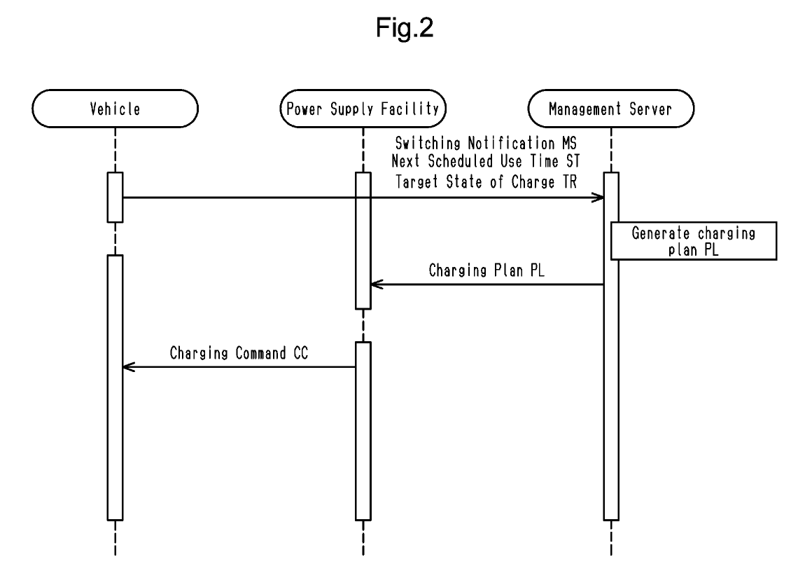

As shown in FIG. 2, when a switching operation from the unplanned charging mode MD1 to the planned charging mode MD2 is performed in the vehicle 20, the vehicle 20 transmits a switching notification MS to the management server 40. The vehicle 20 transmits a signal indicating the next scheduled use time ST and a signal indicating the target state of charge TR to the management server 40 together with the switching notification MS.

When the management server 40 receives the switching notification MS, the management server 40 generates the charging plan PL on the basis of the next scheduled use time ST and the target state of charge TR received together with the switching notification MS.

Thereafter, the management server 40 transmits the generated charging plan PL to the power supply facility 30. When the power supply facility 30 receives the charging plan PL, the power supply facility 30 outputs the charging command CC in accordance with the charging plan PL.

Specifically, the power supply facility 30 generates the charging command CC such that the charging amount per unit time indicated in the charging plan PL is supplied to the battery 23. The power supply facility 30 starts outputting the charging command CC at the start time TS in the charging plan PL.

When the electric vehicle 20 receives the charging command CC according to the charging plan PL from the power supply facility 30, the electric vehicle 20 starts charging the battery 23 in the planned charging mode MD2. When the vehicle 20 no longer acquires the charging command CC from the power supply facility 30, the vehicle 20 ends the charging of the battery 23.

### Series of Processes in Vehicle when Switching Operation Is Performed

When a switching operation is performed on the touchscreen display 25 shown in FIG. 1, the execution device 28 starts execution of the charging prohibition program PR2.

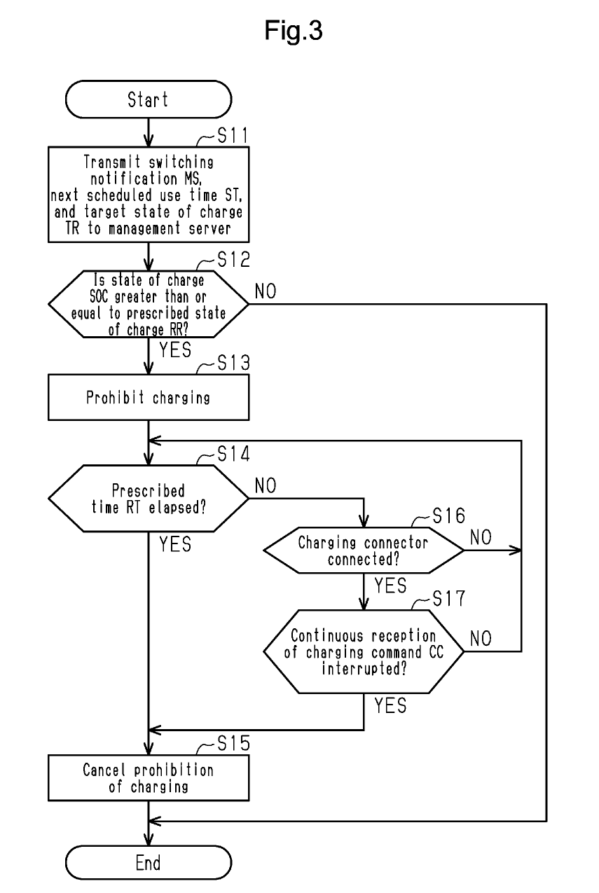

As shown in FIG. 3, when the execution device 28 starts execution of the charging prohibition program PR2, the execution device 28 first executes the process of step S11. In step S11, the execution device 28 transmits the switching notification MS to the management server 40. The execution device 28 transmits a signal indicating the next scheduled use time ST and a signal indicating the target state of charge TR together with the switching notification MS from the communication device 26 to the management server 40. Thereafter, the execution device 28 advances the process to step S12.

In step S12, the execution device 28 determines whether the state of charge SOC of the battery 23 is greater than or equal to a predetermined prescribed state of charge RR. The prescribed rate RR is defined in advance, through testing or simulation, as a state of charge SOC at which immediate charging is required.

When the state of charge SOC is less than the prescribed state of charge RR (S12: NO), the execution device 28 ends the current series of processes. That is, in this case, the execution device 28 does not prohibit charging of the battery 23.

On the other hand, when the state of charge SOC is greater than or equal to the prescribed state of charge RR (S12: YES), the execution device 28 advances the process to step S13. In step S13, the execution device 28 prohibits charging of the battery 23. Specifically, even when the charger 22 acquires the charging command CC from the power supply facility 30, the execution device 28 performs control such that the relay of the charger 22 is not connected but is kept in a disconnected state. That is, the controller 27 prohibits charging of the battery 23 on condition that an operation of switching from the unplanned charging mode MD1 to the planned charging mode MD2 is performed in the vehicle 20 and the state of charge SOC is greater than or equal to the prescribed state of charge RR when the operation is performed. Thereafter, the execution device 28 advances the process to step S14.

In step S14, the execution device 28 determines whether a predetermined prescribed time RT has elapsed since charging of the battery 23 was prohibited by the process of step S13. The prescribed time RT is determined in advance, through testing or simulation, as a time required for the power supply facility 30 to receive the charging plan PL from the management server 40 after the vehicle 20 transmits the switching notification MS to the management server 40 when an assumed communication delay occurs.

When the prescribed time RT has elapsed (S14: YES), the execution device 28 advances the process to step S15. In step S15, the execution device 28 cancels prohibition of charging of the battery 23. Specifically, when the charger 22 acquires the charging command CC from the power supply facility 30, the execution device 28 performs control to switch the relay of the charger 22 to a connected state. That is, the execution device 28 prohibits charging of the battery 23 until the prescribed time RT elapses. Thereafter, the execution device 28 ends the current series of processes.

On the other hand, when the prescribed time RT has not elapsed (S14: NO), the execution device 28 advances the process to step S16. In step S16, the execution device 28 determines whether the charging connector 31 is connected to the charging port 21.

When the charging connector 31 is not connected to the charging port 21 (S16: NO), the execution device 28 returns the process to step S14. On the other hand, when the charging connector 31 is connected to the charging port 21 (S16: YES), the execution device 28 advances the process to step S17.

In step S17, the execution device 28 determines whether continuous reception of the charging command CC from the power supply facility 30 has been interrupted. That is, the execution device 28 determines whether the charging command CC received from the power supply facility 30 is no longer acquired after the process of step S13. Specifically, the execution device 28 repeatedly monitors the presence or absence of the charging command CC to the charger 22, and determines that the charging command CC is no longer acquired when the charger 22 changes from a state of acquiring the charging command CC to a state of not acquiring the charging command CC.

When continuous reception of the charging command CC from the power supply facility 30 is not interrupted (S17: NO), the execution device 28 returns the process to step S14. That is, when the charging command CC has not been acquired at all or when the charging command CC continues to be acquired, the execution device 28 returns the process to step S14.

On the other hand, when continuous reception of the charging command CC from the power supply facility 30 is interrupted (S17: YES), the execution device 28 advances the process to step S15. In a case in which the process of step S15 is performed after an affirmative determination is made in step S17, the execution device 28 cancels prohibition of charging of the battery 23 even if the prescribed time RT has not elapsed. That is, in a state in which the execution device 28 prohibits charging of the battery 23, the execution device 28 cancels prohibition of charging of the battery 23 when the charging connector 31 is connected to the charging port 21 and continuous reception of the charging command CC from the power supply facility 30 is interrupted. Thereafter, the execution device 28 ends the current series of processes.

### Operation of the Present Embodiment

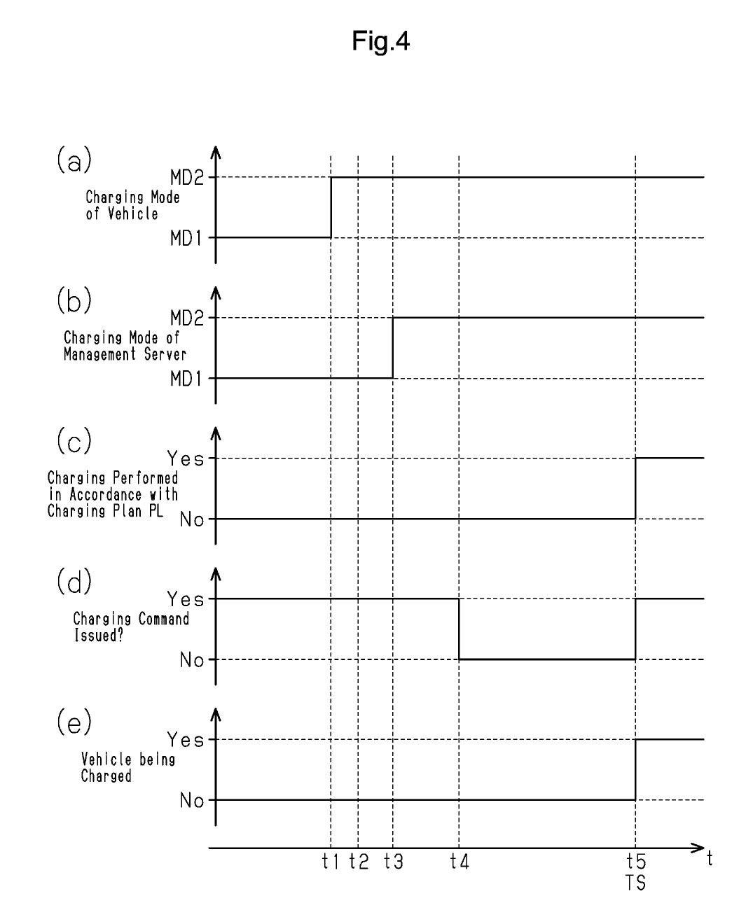

As shown in FIG. 4, an operation of the present embodiment will be described by taking, as an example, a case in which a communication delay occurs in each of communication between the vehicle 20 and the management server 40 and communication between the management server 40 and the power supply facility 30. Before time t1, all of the vehicle 20, the power supply facility 30, and the management server 40 recognize that the charging mode of the vehicle 20 is the unplanned charging mode MD1.

As shown in part (a) of FIG. 4, when the switching operation is performed at time t1, the controller 27 of the electric vehicle 20 recognizes that the charging mode has been switched from the unplanned charging mode MD1 to the planned charging mode MD2. At time t1, the vehicle 20 transmits the switching notification MS to the management server 40. At time t1, the electric vehicle 20 prohibits charging of the battery 23.

In the example shown in FIG. 4, at time t1 after time t2, the charging connector 31 is connected to the charging port 21. In this case, as shown in part (d) of FIG. 4, the power supply facility 30 outputs the charging command CC at the time t2. However, the vehicle 20 prohibits the charging of the battery 23 at the time t1. Therefore, as shown in part (e) of FIG. 4, the battery 23 is not charged at the time t2.

As shown in part (b) of FIG. 4, at the time t3 after the time t2, the management server 40 receives the switching notification MS from the vehicle 20. That is, a communication delay from the time t1 to the time t3 occurs. At the time t3, the management server 40 generates the charging plan PL. Thereafter, the management server 40 transmits the generated charging plan PL to the power supply facility 30.

As shown in part (d) of FIG. 4, at time t4 after time t3, the power supply facility 30 receives the charging plan PL from the management server 40. That is, a communication delay from the time t3 to the time t4 occurs. From time t2 to time t4, the power supply facility 30 is in a state of outputting the charging command CC. At time t4, the power supply facility 30 stops outputting charging command CC.

As shown in part (c) of FIG. 4, the start time TS set in the charging plan PL is the time t5 after the time t4. Therefore, in the charging plan PL, charging of the battery 23 is not requested from the time t1 to the time t5. On the other hand, in the charging plan PL, charging of the battery 23 is requested after the time t5. At time t5, the power supply facility 30 starts outputting the charging command CC according to the charging plan PL. That is, in the charging plan PL, the output of the charging command CC is not requested during a period from the generation of the charging plan PL to the time t5, and the output of the charging command CC is requested after the time t5.

As shown in part (e) of FIG. 4, at the time t5 after the time t4, the electric vehicle 20 acquires the charging command CC according to the charging plan PL, so that the electric vehicle 20 starts charging the battery 23.

In the example shown in FIG. 4, at the time t1, the electric vehicle 20 prohibits charging of the battery 23 until a prescribed time RT elapses from the time t1 to a time after the time t4. Since the charging connector 31 is connected to the charging port 21 at the time t2 and the power supply facility 30 stops the output of the charging command CC at the time t4, the charging of the battery 23 is released at the time t4. Thus, at the time t5, the electric vehicle 20 starts charging the battery 23.

In this way, when the communication delay occurs, even if the charging connector 31 is connected to the charging port 21 in a state in which the power supply facility 30 outputs the charging command CC unrelated to the charging plan PL, the battery 23 of the vehicle 20 is not charged.

### Advantages of the Present Embodiment

(1) For example, a communication delay may occur between the vehicle 20 and the management server 40, or a communication delay may occur between the management server 40 and the power supply facility 30. In such a case, the vehicle 20 acquires the charging command CC unrelated to the charging plan PL from the power supply facility 30 until the power supply facility 30 grasps that the charging mode of the vehicle has been switched from the unplanned charging mode MD1 to the planned charging mode MD2. According to the charging system 10, when the operation of switching from the unplanned charging mode MD1 to the planned charging mode MD2 is performed, the controller 27 prohibits the charging of the battery 23 until the prescribed time RT elapses. Therefore, the charging system 10 can prevent the battery 23 in the vehicle 20 from being charged in the unplanned charging mode MD1 that is not intended by the user.

(2) In the charging system 10, even when the power supply facility 30 outputs the charging command CC in the unplanned charging mode MD1, the power supply facility 30 stops outputting the charging command CC when the power supply facility 30 recognizes that the charging mode is switched from the unplanned charging mode MD1 to the planned charging mode MD2. When the power supply facility 30 stops outputting the charging command CC, the controller 27 can determine that the power supply facility 30 has grasped that the charging mode has been switched from the unplanned charging mode MD1 to the planned charging mode MD2. The controller 27 cancels the prohibition of the charging of the battery 23 in a case in which such a determination is made, and thus it is possible to suppress a situation in which the battery 23 cannot be charged when the charging command CC in the planned charging mode MD2 is output thereafter.

(3) When the controller 27 prohibits the charging of the battery 23, the controller 27 prohibits the charging of the battery 23 on a further condition that the state of charge SOC of the battery 23 is greater than or equal to the prescribed state of charge RR when the operation of switching from the unplanned charging mode MD1 to the planned charging mode MD2 is performed. Therefore, in the charging system 10, when the state of charge SOC of the battery 23 is less than the prescribed state of charge RR, charging of the battery 23 is not prohibited. Therefore, it is possible to prevent the battery 23 from not being charged in a situation where the charging of the battery 23 should be hastily performed against the intention of the user of the vehicle 20.

### Modifications

The above-described embodiment may be modified as follows. The above-described embodiment and the following modifications can be combined as long as the combined modifications remain technically consistent with each other.

Even when the charging connector 31 is connected to the charging port 21 and the controller 27 does not acquire the charging command CC from the power supply facility 30 in a state in which the controller 27 prohibits the charging of the battery 23, the controller 27 may not cancel the prohibition of the charging of the battery 23.

When the controller 27 prohibits the charging of the battery 23, the controller 27 may not set a condition that the state of charge SOC of the battery 23 is greater than or equal to the prescribed state of charge RR when the operation of switching from the unplanned charging mode MD1 to the planned charging mode MD2 is performed as a further condition.

Each of the controller 27, the controller 34, and the information processing device 42 may be processing circuitry including one or more processors that execute at least some of various processes in accordance with a computer program (software), processing circuitry including one or more dedicated hardware circuits such as an application specific integrated circuit (ASIC) that executes at least some of various processes, or processing circuitry including a combination thereof. Each processor includes a CPU and memory such as RAM and ROM. The memory stores program codes or commands configured to cause the CPU to execute processes. The memory, namely, a computer-readable medium, includes any available medium that is accessible by a general-purpose or special-purpose computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A charging system, comprising:
a management server;
a power supply facility configured to communicate with the management server; and
a vehicle configured to communicate with the management server, wherein
the vehicle includes:
a battery;
a charging port; and
a controller configured to control the battery,
the power supply facility includes a charging connector configured to be connected to the charging port,
the management server is configured to generate a charging plan for charging the battery,
the power supply facility is configured to output a charging command for charging the battery to the vehicle,
the vehicle is configured such that a charging mode of the vehicle is switched between an unplanned charging mode and a planned charging mode,
the unplanned charging mode is a mode in which charging of the battery is started when the charging connector is connected to the charging port regardless of the charging plan,
the planned charging mode is a mode in which the battery is charged by the charging command from the power supply facility in accordance with the charging plan,
the vehicle is configured to transmit, to the management server, a switching notification indicating that the charging mode of the vehicle has been switched from the unplanned charging mode to the planned charging mode, when an operation of switching from the unplanned charging mode to the planned charging mode is performed,
the management server is configured to generate, when receiving the switching notification from the vehicle, the charging plan and transmit the charging plan to the power supply facility,
the power supply facility is configured to output, when receiving the charging plan from the management server, the charging command to the vehicle in accordance with the charging plan, and
the controller is configured to prohibit charging of the battery until a predetermined prescribed time elapses on condition that the operation of switching from the unplanned charging mode to the planned charging mode is performed.

2. The charging system according to claim 1, wherein the controller is configured to cancel, in a state in which the controller prohibits charging of the battery, prohibition of charging of the battery when the charging connector of the power supply facility is connected to the charging port of the vehicle and the controller no longer acquires the charging command from the power supply facility.

3. The charging system according to claim 1, wherein the controller is configured to prohibit charging of the battery on a further condition that a state of charge of the battery when an operation of switching from the unplanned charging mode to the planned charging mode is performed is greater than or equal to a predetermined prescribed state of charge.
